(19) United States
(12) Patent Application Publication
(10) Pub. No.: US 2026/0266516 A1
(43) Pub. Date: Sep. 10, 2026

(54) WASTE HEAT-TO-STEAM SUPPLY SYSTEM AND STEAM SUPPLY METHOD FOR ALKALINE ELECTROLYTIC CELLS

(71) Applicant: NORTHWEST ELECTRIC POWER DESIGN INSTITUTE CO., LTD. OF CHINA POWER ENGINEERING CONSULTING GROUP, Xi'an (CN)

(72) Inventors: Xiaohui ZHAO, Xi'an (CN); Anming WANG, Xi'an (CN); Baiyu WANG, Xi'an (CN); Runyu WANG, Xi'an (CN); Yibo XU, Xi'an (CN); Lin FU, Xi'an (CN); Qingchuan BAI, Xi'an (CN); Ye QIANG, Xi'an (CN)

(73) Assignee: NORTHWEST ELECTRIC POWER DESIGN INSTITUTE CO., LTD. OF CHINA POWER ENGINEERING CONSULTING GROUP, Xi'an (CN)

(21) Appl. No.: 19/357,269

(22) Filed: Oct. 14, 2025

(30) Foreign Application Priority Data
Mar. 4, 2025 (CN) 2025102510562

(51) Int. Cl. F25B 27/02; C25B 1/04; C25B 9/67; C25B 15/021

(52) U.S. Cl. CPC F25B 27/02; C25B 1/04; C25B 9/67; C25B 15/021

(57) ABSTRACT

The present disclosure relates to the technical field of electrolytic cell waste heat recovery, and specifically to a waste heat-to-steam supply system and steam supply method for alkaline electrolytic cells. The system includes a waste heat recovery module, a heat pump module and a steam generation and supply module. The waste heat recovery module includes an alkaline electrolysis unit and a cooling unit. The heat pump module includes a first power supply unit, a second power supply unit, an electric motor, and a compressor. The steam generation and supply module includes a steam generation unit and a steam supply unit. In the present disclosure, a heat transfer medium recovers the waste heat of the alkaline electrolytic cell, and after compression and heating, the heat network feedwater is heated and evaporated into high-temperature steam, which is then supplied to industrial steam users.

### CROSS-REFERENCE TO RELATED APPLICATIONS

The application claims priority to Chinese patent application No. 2025102510562, filed on Mar. 4, 2025, the entire contents of which are incorporated herein by reference.

### TECHNICAL FIELD

The present disclosure relates to the technical field of electrolytic cell waste heat recovery, and in particular to a waste heat-to-steam supply system and steam supply method for alkaline electrolytic cells.

### BACKGROUND

In large-scale wind-PV-hydrogen-energy storage integration bases, green hydrogen produced from clean electricity generated by wind power and photovoltaics can be used as a clean fuel for road transportation, shipping, and aerospace. It can also serve as a raw material to generate chemical products such as methanol, ammonia, and methane, or be used as energy storage for power system balance adjustment.

Alkaline electrolytic cells represent the most well-developed technical route for water electrolysis to produce hydrogen, and are commonly used hydrogen production equipment in wind-PV-hydrogen-energy storage integration bases. During the water electrolysis process, such equipment continuously consumes electrical energy, causing the temperature of the electrolytic reaction zone to rise gradually. To ensure the efficient operation of the electrolytic cells, cooling water is required to remove excess heat and maintain the temperature of the electrolytic reaction zone. However, the heat carried away by this cooling water is usually dissipated into the environment through air-cooled coolers, resulting in significant heat waste.

### SUMMARY

The technical problem to be solved by the embodiments of the present disclosure is to provide a waste heat-to-steam supply system and steam supply method for alkaline electrolytic cells, so as to solve the problem of significant heat waste in existing water electrolysis hydrogen production technologies, in which the waste heat carried away from electrolytic cells by cooling water is dissipated into the environment via air cooling.

The present disclosure claims a waste heat-to-steam supply system and steam supply method for alkaline electrolytic cells, including:

a waste heat recovery module, including an alkaline electrolysis unit and a cooling unit; the alkaline electrolysis unit is provided with cooling water, and the cooling unit is provided with a heat transfer medium; the cooling unit is connected to the alkaline electrolysis unit, and is configured to introduce the cooling water into the cooling unit to heat the heat transfer medium;

a heat pump module, including a first power supply unit, a second power supply unit, an electric motor, and a compressor; the first power supply unit and the second power supply unit are respectively electrically connected to the electric motor; the first power supply unit provides green electricity and discarded photovoltaic power, and the second power supply unit provides electric energy as a backup when the first power supply unit does not work; the electric motor is connected to the compressor, and the compressor is connected to the cooling unit, so that the heated heat transfer medium in the cooling unit is introduced into the compressor for compression and heating; and

a steam generation and supply module, including a steam generation unit and a steam supply unit; the steam generation unit is connected to the compressor, so that the compressed and heated heat transfer medium is introduced into the steam generation unit; the steam generation unit is connected to the steam supply unit, so that the heat network feedwater from the outlet of the steam supply unit is introduced into the steam generation unit, heated and evaporated by the heat transfer medium to generate industrial steam, and then provide it to the steam supply unit; the steam generation unit is further connected to the cooling unit, so that the cooled heat transfer medium in the steam generation unit circulates back to the cooling unit and is heated by the cooling water of the alkaline electrolysis unit.

Optionally, a first circulation unit is provided between the alkaline electrolysis unit and the cooling unit. The first circulation unit includes a first delivery pipeline and a first return pipeline. The first delivery pipeline connects the alkaline electrolysis unit and the cooling unit, and is used to introduce the cooling water from the alkaline electrolysis unit into the cooling unit. The first return pipeline connects the alkaline electrolysis unit and the cooling unit, and is used to return the cooled water after heat transfer in the cooling unit to the alkaline electrolysis unit. A first booster pump is provided on the first return pipeline.

Optionally, a second circulation unit is provided between the steam generation unit and the steam supply unit. The second circulation unit includes a second delivery pipeline and a second return pipeline. The second delivery pipeline connects the steam generation unit and the steam supply unit, and is used to deliver the heat network feedwater from the outlet of the steam supply unit into the steam generation unit. A second booster pump is provided on the second delivery pipeline. The second return line connects the steam generation unit and the steam supply unit, and is used to supply the industrial steam generated by the steam generation unit back to the steam supply unit.

Optionally, the first power supply unit includes a main power grid, a transformer, and a first circuit breaker. The main power grid provides green electricity and discarded photovoltaic power, and the main power grid, transformer, first circuit breaker, and electric motor are connected in sequence.

Optionally, the second power supply unit includes an electrochemical energy storage device and a second circuit breaker. The electrochemical energy storage device provides stored electrochemical reaction electricity, and the electrochemical energy storage device, second circuit breaker, and electric motor are connected in sequence.

Optionally, the heat pump module further includes a heat regenerator. The cooling unit is connected to the compressor via the heat regenerator, so that the heated heat transfer medium in the cooling unit passes through the heat regenerator before being introduced into the compressor. The steam generation unit is connected to the cooling unit via the heat regenerator, so that the cooled heat transfer medium in the steam generation unit passes through the heat regenerator, heats the heat transfer medium introduced from the cooling unit, and then is returned to the cooling unit.

Optionally, a first upgrading pipeline is connected between the cooling unit and the heat regenerator, a second upgrading pipeline is connected between the heat regenerator and the compressor, and a third upgrading pipeline is connected between the compressor and the steam generation unit. This allows the heated heat transfer medium in the cooling unit to be introduced into the steam generation unit through the first upgrading pipeline, the second upgrading pipeline, and the third upgrading pipeline in sequence.

A cooling pipeline is connected between the steam generation unit and the heat regenerator, so that the cooled heat transfer medium in the steam generation unit is introduced into the heat regenerator through the cooling pipeline.

Optionally, the heat pump module further includes an expander. The expander is coaxially connected to the drive shaft of the compressor, and the expander is connected to the drive end of the electric motor.

The heat regenerator is connected to the cooling unit via the expander, so that the cooled heat transfer medium in the heat regenerator is introduced into the expander to recover the pressure potential energy and thermal energy, and then introduced into the cooling unit.

Optionally, a working pipeline is connected between the heat regenerator and the expander, and a fourth upgrading pipeline is connected between the expander and the cooling unit. This allows the cooled heat transfer medium in the heat regenerator to be returned to the cooling unit through the working pipeline and the fourth upgrading pipeline in sequence.

The present disclosure further provides a steam supply method, which adopts the preceding waste heat-to-steam supply system for alkaline electrolytic cells. The steam supply method includes:

in response to the operation of the alkaline electrolysis unit, pressurizing and introducing the cooling water from the alkaline electrolysis unit into the cooling unit to heat the heat transfer medium in the cooling unit, and returning the cooled water after heat transfer to the alkaline electrolysis unit;

introducing the heat transfer medium from the cooling unit into the compressor for compression and heating until it reaches a preset temperature;

introducing the heat transfer medium heated in the compressor into the steam generation unit, and introducing the heat network feedwater from the steam supply unit into the steam generation unit until the introduced heat network feedwater is heated and evaporated by the introduced heat transfer medium to generate industrial steam at a preset temperature; and

providing the industrial steam to the steam supply unit, and returning the cooled heat transfer medium from the steam generation unit to the cooling unit for further heat transfer.

Compared with the existing art, the waste heat-to-steam supply system for alkaline electrolytic cells and steam supply method provided by the embodiments of the present disclosure have the following beneficial effects:

By providing the waste heat recovery module, heat pump module, and steam generation and supply module, the heat transfer medium in the cooling unit recovers the waste heat generated by the hydrogen production reaction in the alkaline electrolysis unit. The compressor compresses and heats the heat transfer medium to high-pressure gas with a preset temperature. This high-pressure gas is then introduced into the steam generation unit to heat and evaporate the heat network feedwater from the steam supply unit into high-temperature steam, meeting the steam demand of the steam supply unit and thus supplying industrial steam users. Furthermore, the electric power for the electric motor driving the compressor is jointly provided by green electricity, discarded photovoltaic power, and the electrochemical energy storage device. This effectively solves the problem that the alkaline electrolysis unit, steam supply unit, and other components cannot withstand frequent start-stop cycles. As a result, the waste heat and green electricity in the wind-PV-hydrogen-energy storage integration base are fully utilized to provide high-value-added industrial steam, avoiding significant waste of electrolytic cell waste heat and greatly improving the economic benefits of the base.

### BRIEF DESCRIPTION OF DRAWINGS

The technical solutions of the present disclosure will be further described in detail below with reference to the accompanying drawings and embodiments, in which:

FIG. 1 is a schematic block diagram of the waste heat-to-steam supply system for alkaline electrolytic cells provided by an embodiment of the present disclosure.

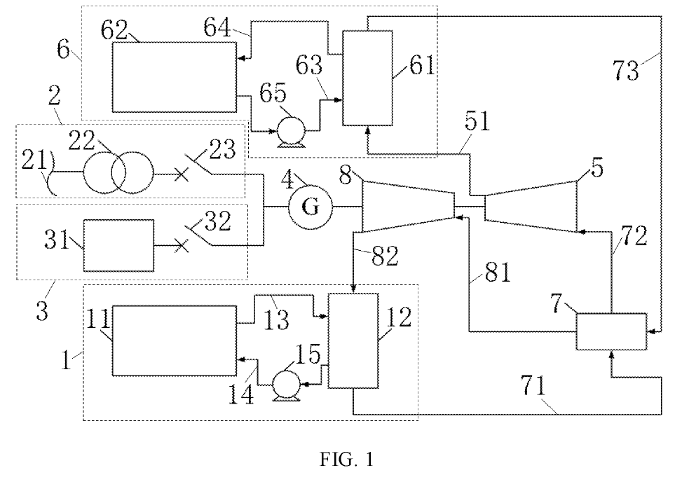

The reference numerals in the figure are:

1. waste heat recovery module; 11. alkaline electrolysis unit; 12. cooling unit; 13. first delivery pipeline; 14. first return pipeline; 15. first booster pump; 2. first power supply unit; 21. main power grid; 22. transformer; 23. first circuit breaker; 3. second power supply unit; 31. electrochemical energy storage device; 32. second circuit breaker; 4. electric motor; 5. compressor; 51. third upgrading pipeline; 6. steam generation and supply module; 61. steam generation unit; 62. steam supply unit; 63. second delivery pipeline; 64. second return pipeline; 65. second booster pump; 7. heat regenerator; 71. first upgrading pipeline; 72. second upgrading pipeline; 73. cooling pipeline; 8. expander; 81. working pipeline; and 82. fourth upgrading pipeline.

### DETAILED DESCRIPTION OF THE EMBODIMENTS

It should be noted that the embodiments and features in the embodiments of the present disclosure may be combined with each other without conflict. The preferred embodiments of the present disclosure will be described in detail below with reference to the accompanying drawings.

The present disclosure claims a waste heat-to-steam supply system for alkaline electrolytic cells, including a waste heat recovery module 1, a heat pump module and a steam generation and supply module 6. The waste heat recovery module 1 includes an alkaline electrolysis unit 11 and a cooling unit 12. The alkaline electrolysis unit 11 is provided with cooling water, and the cooling unit 12 is provided with a heat transfer medium. The cooling unit 12 is connected to the alkaline electrolysis unit 11, and is configured to introduce the cooling water into the cooling unit 12 to heat the heat transfer medium. The heat pump module includes a first power supply unit 2, a second power supply unit 3, an electric motor 4, and a compressor 5. The first power supply unit 2 and the second power supply unit 3 are respectively electrically connected to the electric motor 4. The first power supply unit 2 provides green electricity and discarded photovoltaic power, and the second power supply unit 3 provides electric energy as a backup when the first power supply unit 2 does not work. The electric motor 4 is connected to the compressor 5, and the compressor 5 is connected to the cooling unit 12, so that the heated heat transfer medium in the cooling unit 12 is introduced into the compressor 5 for compression and heating. The steam generation and supply module 6 includes a steam generation unit 61 and a steam supply unit 62. The steam generation unit 61 is connected to the compressor 5, so that the compressed and heated heat transfer medium is introduced into the steam generation unit 61. The steam generation unit 61 is connected to the steam supply unit 62, so that the heat network feedwater from the outlet of the steam supply unit 62 is introduced into the steam generation unit 61, heated and evaporated by the heat transfer medium to generate industrial steam, and then provide it to the steam supply unit 62. The steam generation unit 61 is further connected to the cooling unit 12, so that the cooled heat transfer medium in the steam generation unit 61 circulates back to the cooling unit 12 and is heated by the low-temperature water of the alkaline electrolysis unit 11.

Through the implementation of the preceding embodiment of the waste heat-to-steam supply system for alkaline electrolytic cells, the waste heat recovery module 1, heat pump module, and steam generation and supply module 6 are provided. The alkaline electrolysis unit 11 is an existing alkaline electrolysis device in the wind-PV-hydrogen-energy storage integration base. As the temperature of the electrolytic reaction zone rises gradually during water electrolysis for hydrogen production in the alkaline electrolysis unit 11, the cooling water provided in the alkaline electrolysis unit 11 is used to cool the electrolytic reaction zone. The cooling water is introduced into the cooling unit 12 to heat the heat transfer medium in the cooling unit 12, thereby fully recovering the waste heat generated by the hydrogen production reaction in the alkaline electrolysis unit 11. At this point, the waste heat of the electrolytic reaction zone is transferred from the cooling water to the heat transfer medium, and the heat transfer medium now contains low-grade thermal energy. The compressor 5 is then used to compress and heat the heat transfer medium to high-pressure gas with a preset temperature. Preferably, the heat transfer medium is heated to high-pressure gas at a temperature of not less than 320° C in the compressor 5. This high-pressure gas formed by compression and heating is introduced into the steam generation unit 61 to heat and evaporate the heat network feedwater from the steam supply unit 62 into high-temperature steam, meeting the steam demand of the steam supply unit 62 and thus supplying industrial steam users. Preferably, since the heat transfer medium is heated to high-pressure gas at a temperature of not less than 320° C, the heat network feedwater can be heated and evaporated into steam at approximately 300° C for supply to industrial steam users. Generally, large-scale wind-PV-hydrogen-energy storage integration bases are accompanied by supporting chemical plants that use hydrogen as a raw material, and these chemical plants usually have a large demand for industrial steam at approximately 300° C. Therefore, the embodiment of the present disclosure can provide high-value-added industrial steam. Furthermore, the electric power for the electric motor 4 driving the compressor 5 is jointly provided by green electricity, discarded photovoltaic power, and the electrochemical energy storage device 31. Specifically, the first power supply unit 2 generally provides wind power and discarded photovoltaic power from the wind-PV-hydrogen-energy storage integration base to supply electric power to the electric motor 4; when there is no wind power or discarded photovoltaic power available, the second power supply unit 3 provides electrochemical energy storage from the wind-PV-hydrogen-energy storage integration base to supply electric power to the electric motor 4. The combined power supply of the first power supply unit 2 and the second power supply unit 3 effectively solves the problem that the alkaline electrolysis unit 11, steam supply unit 62, and other components cannot withstand frequent start-stop cycles, and can improve the efficiency of compressing and heating the heat transfer medium into high-temperature gas, thereby enhancing the steam generation efficiency of the steam generation unit 61. Among them, the steam supply unit 62 refers to industrial steam users, typically chemical plants that use hydrogen as a raw material and are supporting facilities around the wind-PV-hydrogen-energy storage integration base; their chemical processes usually cannot withstand frequent start-stop cycles. As a result, waste heat from the alkaline electrolytic cells and green electricity in the wind-PV-hydrogen-energy storage integration base are fully utilized to provide high-value-added industrial steam, avoiding significant waste of electrolytic cell waste heat and greatly improving the economic benefits of the base. Preferably, the cooling unit 12 is a cooler, and the steam generation unit 61 is a steam generator.

Preferably, in the embodiment of the present disclosure, the heat transfer medium may be air, carbon dioxide, argon, helium, nitrogen, or the like. Different heat transfer media correspond to different system coefficients of performance (COP); for the waste heat utilization temperature range of 80° C–65° C of the alkaline electrolytic cell, when providing industrial steam at approximately 300° C, the COP is about 1.1–1.5.

Further, a first circulation unit is provided between the alkaline electrolysis unit 11 and the cooling unit 12. The first circulation unit includes a first delivery pipeline 13 and a first return pipeline 14. The first delivery pipeline 13 connects the alkaline electrolysis unit 11 and the cooling unit 12, and is used to introduce the cooling water from the alkaline electrolysis unit 11 into the cooling unit 12. The first return pipeline 14 connects the alkaline electrolysis unit 11 and the cooling unit 12, and is used to return the cooled water after heat transfer in the cooling unit 12 to the alkaline electrolysis unit 11. A first booster pump 15 is provided on the first return pipeline 14.

Through the implementation of the preceding embodiment of the waste heat-to-steam supply system for alkaline electrolytic cells, the first delivery pipeline 13 can transport the cooling water that has transferred the electrolytic cell waste heat from the alkaline electrolysis unit 11 to the cooling unit 12. The first return pipeline 14 can be used to return the cooling water after heat transfer with the heat transfer medium in the cooling unit 12 to the alkaline electrolysis unit 11 for further recovery of electrolytic cell waste heat. A first heat transfer loop is consisted of the first delivery pipeline 13 and the first return pipeline 14, and enables the waste heat in the alkaline electrolytic cell recover continuously, thus realizing full utilization of the waste heat of the alkaline electrolytic cell. The cooling water in the first heat transfer loop is pressurized by the first booster pump 15 in order to improve the heat transfer performance of the cooling unit 12.

Further, a second circulation unit is provided between the steam generation unit 61 and the steam supply unit 62. The second circulation unit includes a second delivery pipeline 63 and a second return pipeline 64. The second delivery pipeline 63 connects the steam generation unit 61 and the steam supply unit 62, and is used to deliver the heat network feedwater from the outlet of the steam supply unit 62 into the steam generation unit 61. A second booster pump 65 is provided on the second delivery pipeline 63. The second return pipeline 64 connects the steam generation unit 61 and the steam supply unit 62, and is used to supply the industrial steam generated by the steam generation unit 61 back to the steam supply unit 62.

Through the implementation of the preceding embodiment of the waste heat-to-steam supply system for alkaline electrolytic cells, the second delivery pipeline 63 can be used to transport the heat network feedwater from the outlet of the steam supply unit 62 into the steam generation unit 61, and the second return pipeline 64 can be used to supply the industrial steam generated by the steam generation unit 61 back to the steam supply unit 62 for delivery to the supporting chemical plants that use hydrogen as a raw material around the wind-PV-hydrogen-energy storage integration base. A second heat transfer loop can be formed with the second delivery pipeline 63 and the second return pipeline 64 for the heat network feedwater and steam, enabling continuous and repeated heating and evaporation of the heat network feedwater from the steam supply unit 62 to continuously generate high-temperature steam that meets the demand. The second booster pump 65 is configured to pressurize and transport the industrial steam generated by the steam generation unit 61 to the steam supply unit 62. By increasing the steam transportation pressure to overcome pipeline resistance, the stability and continuity of steam supply are ensured.

Further, the first power supply unit 2 includes a main power grid 21, a transformer 22, and a first circuit breaker 23. The main power grid 21 provides green electricity and discarded photovoltaic power, and the main power grid 21, transformer 22, first circuit breaker 23, and electric motor 4 are connected in sequence.

Further, the second power supply unit 3 includes an electrochemical energy storage device 31 and a second circuit breaker 32. The electrochemical energy storage device 31 provides stored electrochemical reaction electricity, and the electrochemical energy storage device 31, second circuit breaker 32, and electric motor 4 are connected in sequence.

Through the implementation of the preceding embodiment of the waste heat-to-steam supply system for alkaline electrolytic cells. In the first power supply unit 2, the green electricity and discarded photovoltaic power are integrated into the heat pump system via the main power grid 21. Green electricity refers to electricity from renewable energy sources in the wind-PV-hydrogen-energy storage integration base, such as wind energy and solar energy, while discarded photovoltaic power refers to excess solar photovoltaic power that cannot be utilized in a timely manner. This configuration reduces reliance on traditional fossil fuels, lowers carbon emissions, and advances sustainable development. Furthermore, the utilization of discarded photovoltaic power avoids power waste and improves energy utilization efficiency. The electrochemical energy storage device 31 in the second power supply unit 3 can store electricity and release it when needed, helping to smooth load fluctuations in the power system of the wind-PV-hydrogen-energy storage integration base and optimize power system dispatching. The first circuit breaker 23 and second circuit breaker 32 act as protective devices; they can quickly cut off the circuit in the event of a short circuit or overload, protecting system equipment and personnel safety, and enabling switching between the first power supply unit 2 and the second power supply unit 3. That is to say, by closing both the first circuit breaker 23 and the second circuit breaker 32, power can be supplied jointly by the first power supply unit 2 and the second power supply unit 3. Alternatively, only the first circuit breaker 23 is closed, so that the first power supply unit 2 provides wind power and discarded photovoltaic power from the wind-PV-hydrogen-energy storage integration base to supply electric power to the electric motor 4; when there is no wind power or discarded photovoltaic power available, the second circuit breaker 32 is closed, and the second power supply unit 3 provides electrochemical energy storage from the wind-PV-hydrogen-energy storage integration base to supply electric power to the electric motor 4. The configuration of the first power supply unit 2 and the second power supply unit 3 provides dual power supply guarantees. Even if the main power grid 21 fails or power supply is unstable, the electrochemical energy storage device 31 can provide backup power to ensure the continuous operation of equipment such as the electric motor 4 and the compressor 5. This fully utilizes the electricity in the wind-PV-hydrogen-energy storage integration base and improves the economic benefits of the base. Moreover, no fossil fuels are used in the entire process, resulting in significant environmental benefits. It complies with policies related to green electricity-based hydrogen, ammonia, and alcohol production, and can enjoy corresponding subsidies for the final products.

Further, the heat pump module further includes a heat regenerator 7. The cooling unit 12 is connected to the compressor 5 via the heat regenerator 7, so that the heated heat transfer medium in the cooling unit 12 passes through the heat regenerator 7 before being introduced into the compressor 5. The steam generation unit 61 is connected to the cooling unit 12 via the heat regenerator 7, so that the cooled heat transfer medium in the steam generation unit 61 passes through the heat regenerator 7, heats the heat transfer medium introduced from the cooling unit 12, and then is returned to the cooling unit 12.

Further, a first upgrading pipeline 71 is connected between the cooling unit 12 and the heat regenerator 7, a second upgrading pipeline 72 is connected between the heat regenerator 7 and the compressor 5, and a third upgrading pipeline 51 is connected between the compressor 5 and the steam generation unit 61. This allows the heated heat transfer medium in the cooling unit 12 to be introduced into the steam generation unit 61 through the first upgrading pipeline 71, the second upgrading pipeline 72, and the third upgrading pipeline 51 in sequence. A cooling pipeline 73 is connected between the steam generation unit 61 and the heat regenerator 7, so that the cooled heat transfer medium in the steam generation unit 61 is introduced into the heat regenerator 7 through the cooling pipeline 73.

Through the implementation of the preceding embodiment of the waste heat-to-steam supply system for alkaline electrolytic cells, the heat regenerator 7 is provided. Since the heat transfer medium is first compressed and heated to a high temperature by the compressor 5 before entering the steam generation unit 61 to heat and evaporate the heat network feedwater, the heat transfer medium after heat transfer in the steam generation unit 61 still retains low-temperature heat. The cooling pipeline 73 is used to introduce the heat transfer medium after heat transfer from the steam generation unit 61 into the heat regenerator 7. Furthermore, before the heat transfer medium from the cooling unit 12 enters the compressor 5, it is first introduced into the heat regenerator 7 via the first upgrading pipeline 71. In the heat regenerator 7, the heat transfer medium introduced from the steam generation unit 61 heats the heat transfer medium introduced from the cooling unit 12, thereby fully utilizing the low-temperature heat of the heat transfer medium from the outlet of the steam generation unit 61, further recovering heat, and improving the cycle efficiency and heat utilization efficiency of the system. At this point, the heat regenerator 7 is provided with two fluid channels for heat transfer: the heated heat transfer medium enters the compressor 5 through the second upgrading pipeline 72, and the heat transfer medium compressed and heated in the compressor 5 is introduced into the steam generation unit 61 through the third upgrading pipeline 51. Meanwhile, the cooled heat transfer medium in the heat regenerator 7 flows to the cooling unit 12. The arrangement of various pipelines in the system helps optimize the heat transfer process, and through reasonable fluid paths and pressure control, heat transfer efficiency is improved.

Further, the heat pump module further includes an expander 8. The expander 8 is coaxially connected to the drive shaft of the compressor 5, and the expander 8 is connected to the drive end of the electric motor 4.

The heat regenerator 7 is connected to the cooling unit 12 via the expander 8, so that the cooled heat transfer medium in the heat regenerator 7 is introduced into the expander 8 to recover the pressure potential energy and thermal energy, and then introduced into the cooling unit 12.

Further, a working pipeline 81 is connected between the heat regenerator 7 and the expander 8, and a fourth upgrading pipeline 82 is connected between the expander 8 and the cooling unit 12. This allows the cooled heat transfer medium in the heat regenerator 7 to be returned to the cooling unit 12 through the working pipeline 81 and the fourth upgrading pipeline 82 in sequence.

Through the implementation of the preceding embodiment of the waste heat-to-steam supply system for alkaline electrolytic cells, the expander 8 is provided. The cooled heat transfer medium in the heat regenerator 7 enters the expander 8 through the working pipeline 81 to recover the thermal energy and pressure potential energy of the heat transfer fluid (HTF). By coaxially connecting the expander 8 to the drive shaft of the compressor 5, the shaft power of expander 8 is supplied to the compressor 5. The expander 8 is connected to the electric motor 4, so that the shaft power of the compressor 5 is jointly provided by the expander 8 and the electric motor 4. As a result, the shaft power provided by the expander 8 can effectively reduce the electric power required from the electric motor 4. While maintaining the same steam generation efficiency, the thermal energy in the system is fully utilized to reduce the electric power required from the electric motor 4, significantly reducing power consumption and operating costs. Additionally, the system can convert thermal energy into useful work more efficiently, thereby improving overall energy efficiency. After doing work in the expander 8, the heat transfer medium enters the cooling unit 12 through the fourth upgrading pipeline 82 to continue heat transfer with the cooling water that has recovered the alkaline electrolytic cell waste heat, thus completing the entire cycle.

The present disclosure further provides a steam supply method, which adopts the preceding waste heat-to-steam supply system for alkaline electrolytic cells. The steam supply method includes:

in response to the operation of the alkaline electrolysis unit 11, pressurizing and introducing the cooling water from the alkaline electrolysis unit 11 into the cooling unit 12 to heat the heat transfer medium in the cooling unit 12, and returning the cooled water after heat transfer to the alkaline electrolysis unit 11;

introducing the heat transfer medium from the cooling unit 12 into the compressor 5 for compression and heating until it reaches a preset temperature;

introducing the heat transfer medium heated in the compressor 5 into the steam generation unit 61, and introducing the heat network feedwater from the steam supply unit 62 into the steam generation unit 61 until the introduced heat network feedwater is heated and evaporated by the introduced heat transfer medium to generate industrial steam at a preset temperature; and

providing the industrial steam to the steam supply unit 62, and returning the cooled heat transfer medium from the steam generation unit 61 to the cooling unit 12 for further heat transfer.

Through the implementation of the preceding embodiment of the steam supply method, after the heat transfer medium recovers the waste heat from the alkaline electrolytic cell module in the cooling unit 12, it enters the compressor 5 for compression. At this point, green electricity and discarded photovoltaic power, or electrochemical electricity, start the compressor 5 via the electric motor 4, converting the heat transfer medium into high-grade thermal energy, which is then transported to the steam generation unit 61. The heat network feedwater from the steam supply unit 62 exchanges heat with the heat transfer medium in the steam generation unit 61, is evaporated into steam at approximately 300° C, and is supplied to steam users. As a result, waste heat from the alkaline electrolytic cells and green electricity in the wind-PV-hydrogen-energy storage integration base are fully utilized to provide high-value-added industrial steam, avoiding significant waste of electrolytic cell waste heat and greatly improving the economic benefits of the base.

It should be understood that the above embodiments are only used to illustrate the technical solutions of the present disclosure, not to limit them. For those skilled in the art, the technical solutions described in the preceding embodiments can be modified, or some of the technical features can be equivalently replaced; all such modifications and replacements shall fall within the protection scope of the present disclosure.

What is claimed is:

1. A waste heat-to-steam supply system for alkaline electrolytic cells, comprising:
a waste heat recovery module, including an alkaline electrolysis unit and a cooliing unit; the alkaline electrolysis unit is provided with cooling water, and the cooling unit is provided with a heat transfer medium; the cooling unit is connected to the alkaline electrolysis unit, and is configured to introduce the cooling water into the cooling unit to heat the heat transfer medium;
a heat pump module, including a first power supply unit, a second power supply unit, an electric motor, and a compressor; the first power supply unit and the second power supply unit are respectively electrically connected to the electric motor; the first power supply unit provides green electricity and discarded photovoltaic power, and the second power supply unit provides electric energy as a backup when the first power supply unit does not work; the electric motor is connected to the compressor, and the compressor is connected to the cooling unit, so that the heated heat transfer medium in the cooling unit is introduced into the compressor for compression and heating;
and the first power supply unit comprises a main power grid, a transformer, and a first circuit breaker; the main power grid provides green electricity and discarded photovoltaic power, and the main power grid, transformer, first circuit breaker, and electric motor are connected in sequence;the second power supply unit comprises an electrochemical energy storage device and a second circuit breaker; the electrochemical energy storage device provides stored electrochemical reaction electricity, and the electrochemical energy storage device, second circuit breaker, and electric motor are connected in sequence; a steam generation and supply module, comprising a steam generation unit and a steam supply unit; the steam generation unit is connected to the compressor, so that the compressed and heated heat transfer medium is introduced into the steam generation unit; the steam generation unit is connected to the steam supply unit, so that the heat network feedwater from the outlet of the steam supply unit is introduced into the steam generation
unit, heated and evaporated by the heat transfer medium to generate industrial steam, and then provided it to the steam supply unit: the steam generation unit is further connected to the cooling unit, so that the cooled heat transfer medium in the steam generation unit circulates back to the cooling unit and is heated by the low-temperature water of the alkaline electrolysis unit;the heat pump module further comprises a heat regenerator; the cooling unit is connected to the compressor via the heat regenerator, so that the heated heat transfer medium in the cooling unit passes through the heat regenerator before being introduced into the compressor; the steam generation unit is connected to the cooling unit via the heat regenerator, so that the cooled heat transfer medium in the steam generation unit passes through the heat regenerator, heats the heat transfer medium introduced from the cooling unit, and then is returned to the cooling unit;the heat pump module further comprises an expander; the expander is coaxially connected to the drive shaft of the compressor, and the expander is connected to the drive end of the electric motor; andThe heat regenerator is connected to the cooling unit via the expander, so that the cooled heat transfer medium in the heat regenerator is introduced into the expander to recover the pressure potential energy and thermal energy, and then introduced into the cooling unit.

2. The waste heat-to-steam supply system for alkaline electrolytic cells according to claim 1, wherein a first circulation unit is provided between the alkaline electrolysis unit and the cooling unit; the first circulation unit comprises a first delivery pipeline and a first return pipeline; the first delivery pipeline connects the alkaline electrolysis unit and the cooling unit, and is used to introduce the cooling water from the alkaline electrolysis unit into the cooling unit; the first return pipeline connects the alkaline electrolysis unit and the cooling unit, and is used to return the cooled water after heat transfer in the cooling unit to the alkaline electrolysis unit; a first booster pump is provided on the first return pipeline.

3. The waste heat-to-steam supply system for alkaline electrolytic cells according to claim 1 wherein a second circulation unit is provided between the steam generation unit and the steam supply unit; the second circulation unit comprises a second delivery pipeline and a second return pipeline; the second delivery pipeline connects the steam generation unit and the steam supply unit, and is used to deliver the heat network feedwater from the outlet of the steam supply unit into the steam generation unit; a second booster pump is provided on the second delivery pipeline; the second return pipeline connects the steam generation unit and the steam supply unit, and is used to supply the industrial steam generated by the steam generation unit back to the steam supply unit.

4. The waste heat-to-steam supply system for alkaline electrolytic cells according to claim 1, wherein a first upgrading pipeline is connected between the cooling unit and the heat regenerator;
a second upgrading pipeline is connected between the heat regenerator and the compressor; a third upgrading pipeline is connected between the compressor and the steam generation unit; this allows the heated heat transfer medium in the cooling unit to be introduced into the steam generation unit through the first upgrading pipeline, the second upgrading pipeline, and the third upgrading pipeline in sequence;A cooling pipeline is connected between the steam generation unit and the heat regenerator, so that the cooled heat transfer medium in the steam generation unit is introduced into the heat regenerator through the cooling pipeline.

5. The waste heat-to-steam supply system for alkaline electrolytic cells according to claim 4 wherein a working pipeline is connected between the heat regenerator and the expander; a fourth upgrading pipeline is connected between the expander and the cooling unit; this allows the cooled heat transfer medium in the heat regenerator to be returned to the cooling unit through the working pipeline and the fourth upgrading pipeline in sequence.

6. A steam supply method, adopting the waste heat-to-steam supply system for alkaline electrolytic cells according to claim 1, wherein the steam supply method comprises:
in response to the operation of the alkaline electrolysis unit, pressurizing and introducing the
cooling water from the alkaline electrolysis unit into the cooling unit to heat the heat transfer medium in the cooling unit, and returning the cooled water after heat transfer to the alkaline electrolysis unit;introducing the heat transfer medium from the cooling unit into the compressor for compression and heating until it reaches a preset temperature:introducing the heat transfer medium heated in the compressor into the steam generation unit, and introducing the heat network feedwater from the steam supply unit into the steam generation unit until the introduced heat network feedwater is heated and evaporated by the introduced heat transfer medium to generate industrial steam at a preset temperature; andproviding the industrial steam to the steam supply unit, and returning the cooled heat transfer medium from the steam generation unit to the cooling unit for further heat transfer.
